(19) United States
(12) Patent Application Publication
(10) Pub. No.: US 2020/0388857 A1
(43) Pub. Date: Dec. 10, 2020

(54) REDOX FLOW BATTERIES EMPLOYING DIAMOND

(71) Applicant: University of Louisville Research Foundation, Inc., Louisville, KY (US)

(72) Inventors: Mahendra K. Sunkara, Louisville, KY (US); William F. Paxton, Louisville, KY (US); Alex M. Bates, Louisville, KY (US)

(21) Appl. No.: 16/890,311

(22) Filed: Jun. 2, 2020

Related U.S. Application Data
(60) Provisional application No. 62/859,339, filed on Jun. 10, 2019.

(51) Int. Cl. H01M 4/96; H01M 4/86; H01M 8/18

(52) U.S. Cl. CPC H01M 4/96; H01M 4/8605; H01M 2004/8684; H01M 2004/8689; H01M 8/188

(57) ABSTRACT

A redox flow battery comprising a positive electrode; a negative electrode; and an ion-exchange separator, wherein at least one of the positive electrode and the negative electrode is a conductive diamond electrode, and wherein a positive electrode electrolyte and/or a negative electrode electrolyte is in contact with diamond is provided. A boron doped diamond configured as an electrode in a redox flow battery is also provided.

### CROSS-REFERENCE TO RELATED APPLICATIONS

This application claims priority to U.S. Provisional Application 62/859,339 filed Jun. 10, 2019, the complete contents of which is incorporated herein by reference.

### FIELD OF THE INVENTION

The invention generally relates to redox flow batteries having a conductive diamond electrode and cost effective and high energy density electrochemical couples. The batteries have applications in energy storage, for example, in the renewable energy field.

### BACKGROUND OF THE INVENTION

Redox flow batteries (RFBs) have potential for solving the stationary energy storage challenge at various scales from home to grid scale. The separation of power and energy is accomplished by storing the liquid electrolyte (energy) in tanks and flowing the electrolyte through an electrochemical cell (power). Increasing the storage capacity can be accomplished by simply increasing the volume of electrolyte. Similarly, increasing the peak power output and input is accomplished by increasing the size of the electrochemical cell. This ability to separate power and energy make RFBs easily scalable to any grid-scale energy storage need.

RFBs are primarily based on vanadium redox couples which can achieve energy efficiencies between 75 and 85%, lifetimes greater than 10,000 cycles (>20 years), and minimal maintenance costs due to few moving parts (Alotto, Guarnieri, & Moro, 2014; Reynard, Dennison, Battistel, & Girault, 2018; Soloveichik, 2015; Xu et al., 2018; Yang, 2017).

The all-vanadium RFB has been implemented at the MW scale and has been the standard in RFB technology (Laboratories, 2018). The various oxidation states of vanadium are separated into two redox couples, one operating in the anolyte (V²⁺ and V³⁺) and the other in the catholyte (V⁴⁺ and V⁵⁺). These two redox couples produce an inherent potential across the cell. One of the primary reasons for the effectiveness of vanadium is that the inherent potential in the redox couples resides near the potential at which the hydrogen evolution reaction (HER) and oxygen evolution reaction (OER) occur. This trait allows for the system to operate mostly inside the electrochemical window of water, to maximize the discharge potential. The discharge potential serves to increase the energy and power density of the battery. Energy and power density directly correlate to system size, which ultimately determine the capital cost of the energy storage system. Thereby, a greater potential difference across the cell can result in a substantial reduction of system cost.

The availability of vanadium is limited to few countries making it both expensive and an issue with U.S. national energy security. The overall cost of RFBs have yet to meet goals driven by the competition between renewable and non-renewable power sources, primarily due to the high cost of vanadium itself. The potential difference offered by the all-vanadium RFB is low compared to a Li-ion battery. Without a significant change in the cost of vanadium (which is unlikely as vanadium is a rare element), vanadium-based RFBs will never be economically feasible for grid-scale storage. Therefore, alternative, non-vanadium-based, RFB chemistries using more cost-effective electrolytes are needed.

### SUMMARY

Aspects of the disclosure provide a redox flow battery, comprising a positive electrode; a positive electrode electrolyte which contains a first type of redox active material, wherein the positive electrode electrolyte is in contact with the positive electrode; a negative electrode; a negative electrode electrolyte which contains a second type of redox active material, wherein the negative electrode electrolyte is in contact with the negative electrode; and an ion-exchange separator between the positive electrode electrolyte and the negative electrode electrolyte configured to charge and discharge the battery, wherein at least one of the positive electrode and the negative electrode is a conductive diamond electrode, and wherein at least one of the positive electrode electrolyte and the negative electrode electrolyte is in contact with diamond.

In some embodiments, the diamond contacted by the at least one of the positive electrode electrolyte and the negative electrode electrolyte is in the conductive diamond electrode. In some embodiments, both the positive electrode and the negative electrode are conductive diamond electrodes. In some embodiments, both the positive electrode electrolyte and the negative electrode electrolyte are in contact with diamond.

In some embodiments, the conductive diamond electrode is made of at least one type of material selected from the group consisting of boron doped diamond, nitrogen incorporated diamond, phosphorus doped diamond, a composite material including a p-type conductive diamond layer and a n-type conductive diamond layer, and a composite material including a doped diamond with a metal oxide thin film including at least one type of metal. In some embodiments, the conductive diamond electrode is the composite material including the doped diamond and the metal oxide thin film, wherein the doped diamond is boron doped diamond, and wherein the metal oxide thin film includes one or more metals selected from the group consisting of titanium, molybdenum, tin, and tungsten. In some embodiments, the conductive diamond electrode is grown on a patterned substrate. In some embodiments, the conductive diamond electrode is grown on a porous substrate. In some embodiments, the conductive diamond electrode is porous. In some embodiments, the conductive diamond electrode is etched.

In some embodiments, the first type of redox active material is different from the second type of redox active material. In some embodiments, the first type of redox active material is the same as the second type of redox active material. In some embodiments, each of the positive electrode electrolyte and the negative electrode electrolyte, which may be the same or different, contain at least one type of redox couple selected from the group consisting of transition metals, lanthanides, and halogens. In some embodiments, the at least one type of redox couple is a transition metal selected from the group consisting of Ti, V, Cr, Mn, Fe, Co, Cu, Zn, Ag, and Sn. In some embodiments, the at least one type of redox couple is Ce. In some embodiments, the at least one type of redox couple is a halogen selected from the group consisting of chlorine, bromine, and iodine.

In some embodiments, the positive electrode electrolyte contains at least one type of redox couple and has a thermodynamic potential of not less than 1 volt. In some embodiments, the negative electrode electrolyte contains at least one type of redox couple and has a thermodynamic potential of not more than 0.8 volts. In some embodiments, each of the positive electrode electrolyte and the negative electrode electrolyte have a concentration of not less than 0.1 M and not more than 10 M.

In some embodiments, each of the positive electrode electrolyte and the negative electrode electrolyte contains a solvent which may be the same or different for the positive electrode electrolyte and the negative electrode electrolyte, wherein the solvent is an aqueous solution containing at least one species selected from the group consisting of H₂SO₄, HCl, HClO₄, CH₃SO₃H, K₂SO₄, Na₂SO₄, H₃PO₄, K₂PO₄, Na₃PO₄, K₃PO₄, H₄P₂O₇, HNO₃, KNO₃, NaNO₃, NaOH, and KOH.

In some embodiments, the ion-exchange separator is selected from the group consisting of a cation exchange membrane, an anion exchange membrane, and a microporous separator. In some embodiments, the ion-exchange separator is or includes nafion.

Another aspect of the disclosure provides boron doped diamond configured as an electrode in a redox flow battery.

Another aspect of the disclosure provides boron doped diamond configured as at least one of the positive and negative electrodes of a redox flow battery as described herein.

Another aspect of the disclosure provides a conductive diamond configured as an electrode in a redox flow battery whereby either redox couple is of any species other than those containing Mn or Ti.

Another aspect of the disclosure provides a conductive diamond configured as at least one of the positive and negative electrodes of a redox flow battery as described herein whereby either redox couple is of any species other than those containing Mn or Ti.

### BRIEF DESCRIPTION OF THE DRAWINGS

FIG. 1 is a schematic drawing of an all vanadium redox flow battery.

FIG. 2 is a graph showing the current density versus potential for a variety of electrodes. Shown is a comparison of various electrodes for water splitting with cyclic voltammetry in 0.5M sulfuric acid at 200 mV/sec scan rate.

FIGS. 3A-3C are progressively higher magnification SEM images of boron doped diamond electrode.

FIG. 4 is a graph showing cyclic voltammetry of manganese redox couple using platinum foil and diamond electrodes.

FIG. 5 is a graph showing cyclic voltammetry of the iron redox couple using platinum wire and diamond electrodes.

FIG. 6 is a graph showing cyclic voltammetry of the copper redox couple using a diamond electrode.

FIG. 7 is a graph showing cyclic voltammetry of cobalt redox couple using a diamond electrode.

FIG. 8 is a graph showing cyclic voltammetry of cerium redox couple using a diamond electrode.

FIG. 9 is a graph showing cyclic voltammetry of the titanium redox couple using a diamond electrode.

### DETAILED DESCRIPTION

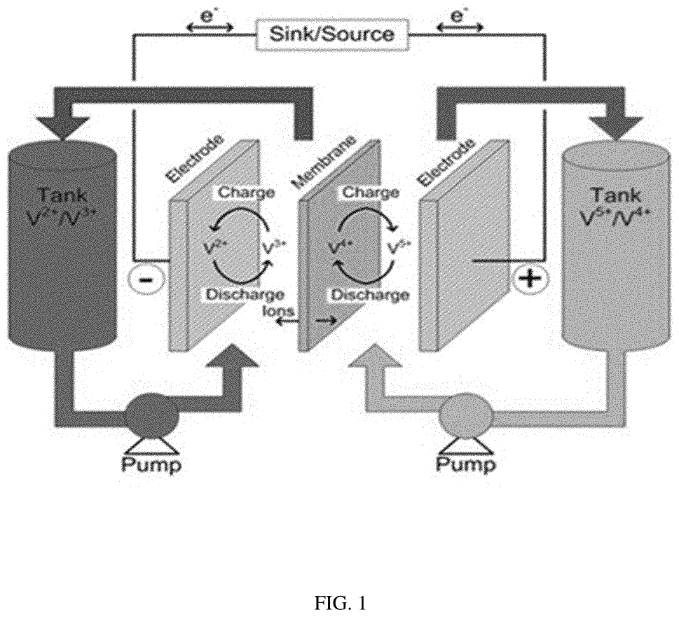

Here we describe, using a variety of embodiments, configurations and chemistries, higher voltage redox flow battery (RFB) systems using aqueous electrolytes. A redox battery is a secondary battery in which an active material in an electrolyte is oxidized, reduced, charged and discharged, and is an electrochemical storage device that directly stores chemical energy of an electrolyte as electrical energy. The general configuration shown in FIG. 1, and variants thereon, can be used in the practice of the invention. As shown in FIG. 1, electrolyte storage tanks are provided on the left (anolyte) and right (catholyte). The electrochemical cell is shown in the middle with the corresponding exemplary vanadium redox couples at the anode (left) and cathode (right).

Embodiments of the disclosure provide a redox flow battery, comprising a positive electrode; a positive electrode electrolyte which contains a first type of redox active material, wherein the positive electrode electrolyte is in contact with the positive electrode; a negative electrode; a negative electrode electrolyte which contains a second type of redox active material, wherein the negative electrode electrolyte is in contact with the negative electrode; and an ion-exchange separator between the positive electrode electrolyte and the negative electrode electrolyte configured to charge and discharge the battery, wherein at least one of the positive electrode and the negative electrode is a conductive diamond electrode, and wherein at least one of the positive electrode electrolyte and the negative electrode electrolyte is in contact with diamond.

In general, an electrolyte is prepared by dissolving transition metals in a strong acid solution. The electrolyte is not stored in the electrodes, but is stored in the liquid state in external electrolyte tanks and in pumps during the charging/discharging process.

The electrolyte solutions described herein contain a redox active material. In some embodiments, a first type of redox active material within the positive electrode electrolyte is different from a second type of redox active material within the negative electrode electrolyte. In some embodiments, the first type of redox active material is the same as the second type of redox active material. In some embodiments, each of the positive electrode electrolyte and the negative electrode electrolyte, which may be the same or different, contain at least one type of redox couple selected from the group consisting of transition metals, lanthanides, and halogens. In some embodiments, the at least one type of redox couple is a transition metal selected from the group consisting of Ti, V, Cr, Mn, Fe, Co, Cu, Zn, Ag, and Sn. In some embodiments, the at least one type of redox couple is Ce. In some embodiments, the at least one type of redox couple is a halogen selected from the group consisting of chlorine, bromine, and iodine. Some embodiments of the disclosure provide a redox flow battery whereby either redox couple is of any species other than those containing Mn or Ti.

As described in the Example, a diamond electrode doped with an electrically conductive element such as boron allows for high activity with redox active couples while reducing the evolution of oxygen and hydrogen from water. The majority of redox couples suffer from competition with gas evolution. Embodiments of the disclosure provide the use of a manganese redox couple among various other redox couples for construction of a flow battery. Exemplary redox couples include, but are not limited to, the following:

Manganese redox couple:

Mn³⁺+e⁻ [symbol] Mn²⁺ E°=1.5415 V (vs. SHE)
(Van\grave{y}sek, 1996)

### Manganese/Titanium Mixed Electrolyte Redox Couples:

TiO²⁺+2H⁺+e⁻ [symbol] Ti^{3←}+H₂O E°=0.1 V (vs. SHE)

Ti³⁺+Mn³⁺+H₂O [symbol] TiO^{2→}+Mn^{2←}+2H^{←}E=1.41 V
(Dong-Jun, Kwang-Sun, Cheol-Hwi, & Gab-Jin, 2017)
   Higher electron
   Catholyte redox couples

CeOH³⁺+H⁺+e⁻ [symbol] Ce³⁺+H₂O E°=1.715 V (vs. SHE)

Ag^{3←}+e⁻ [symbol] Ag^{2←} E°=1.80 V (vs. SHE)

Co^{3→}+e⁻ [symbol] Co²⁺ E°=1.92 V (vs. SHE)

FeO₄²⁻+8H⁺+3e⁻ [symbol] Fe³⁺+4H₂O E°=2.20 V (vs. SHE)

Cu^{3→}+e⁻ [symbol] Cu^{2→} E°=2.40V (vs. SHE)

Anolyte redox couples

Cr³⁺+e⁻ [symbol] Cr²⁺ E°=−0.407 V (vs. SHE)

Fe²⁺+3e⁻ [symbol] Fe E°=−0.447 V (vs. SHE)

In³⁺+2e⁻ [symbol] In²⁺ E°=−0.49 V (vs. SHE)

Zn^{3→}+2e⁻ [symbol] Zn E°=−0.7618 (vs. SHE)

Ti³⁺+e⁻ [symbol] Ti²⁺ E°=−0.9 V (vs. SHE)
(Vanýsek, 1996)

Manganese is substantially more abundant compared to vanadium and, as a result, much cheaper. As of 2018, the cost of 98% vanadyl sulfate is $30,000 per ton, while 99% manganese sulfate is 1,200 per ton (Made-in-China.com, 2018). The manganese redox couple operates at a more positive potential compared to the vanadium catholyte. Manganese can offer a higher energy and power density compared to vanadium, by utilizing the larger potential window made available with boron doped diamond (BDD) as the electrode. BDD stands to drastically decrease the per kWh cost of renewable energy, catapulting renewable energy beyond non-renewables.

In some embodiments, the positive electrode electrolyte contains at least one type of redox couple and has a thermodynamic potential of not less than 1 volt, e.g. at least 1, 1.1, 1.2, 1.3, 1.4, 1.5 volt or more. In some embodiments, the negative electrode electrolyte contains at least one type of redox couple and has a thermodynamic potential of not more than 0.8 volts, e.g. less than 0.8, 0.7, 0.6, 0.5, 0.4 volt or less. In some embodiments, each of the positive electrode electrolyte and the negative electrode electrolyte have a concentration of not less than 0.1 M and not more than 10 M, e.g. between about 0.5-9 M, 1-8 M, or 2-6 M.

In some embodiments, each of the positive electrode electrolyte and the negative electrode electrolyte contains a solvent which may be the same or different for the positive electrode electrolyte and the negative electrode electrolyte, wherein the solvent is an aqueous solution containing at least one species selected from the group consisting of H₂SO₄, HCl, HClO₄, CH₃SO₃H, K₂SO₄, Na₂SO₄, H₃PO₄, K₂PO₄, Na₃PO₄, K₃PO₄, H₄P₂O₇, HNO₃, KNO₃, NaNO₃, NaOH, and KOH.

The positive and negative electrodes may be inactive electrodes, and the electrode itself reacts between the surface of the electrode and the electrolyte without a chemical reaction. In some embodiments, the electrode may comprise graphite, titanium, aluminum or copper. In some embodiments, the electrode comprises a conductive diamond electrode. In some embodiments, both the positive electrode and the negative electrode are conductive diamond electrodes. In some embodiments, both the positive electrode electrolyte and the negative electrode electrolyte are in contact with diamond.

In some embodiments, the conductive diamond electrode is made of at least one type of material selected from the group consisting of boron doped diamond, nitrogen incorporated diamond, phosphorus doped diamond, a composite material including a p-type conductive diamond layer and a n-type conductive diamond layer, and a composite material including a doped diamond with a metal oxide thin film including at least one type of metal.

In some embodiments, the conductive diamond electrode is a composite material including a doped diamond and a metal oxide thin film, wherein the doped diamond is boron doped diamond, and wherein the metal oxide thin film includes one or more metals selected from the group consisting of titanium, molybdenum, tin, and tungsten.

An electrode may be fabricated by depositing a conductive diamond on a substrate via a hot filament CVD (Chemical Vapor Deposition) method, a microwave plasma CVD method, a plasma arc jet method, a PVD (Physical Vapor Deposition) method, among other methods. The substrate can have any shape (such as planar or curved) and be in the form of a low surface area planar substrate or a high surface area substrate as a mesh, foam or particle substrate. The substrate can also be a composite of multiple electrically conductive substrates. In some embodiments, the conductive diamond electrode is grown on a patterned substrate. In some embodiments, the conductive diamond electrode is grown on a porous substrate. In some embodiments, the conductive diamond electrode is porous. In some embodiments, the conductive diamond electrode is etched.

In CVD, an organic compound such as methane, alcohol or acetone as carbon source, and at least one of boron, nitrogen, phosphorus and the like as a dopant for imparting conductivity are supplied to a CVD apparatus containing therein a filament and a conductive substrate to be covered with diamond formed, together with hydrogen gas or the like. The filament is heated to a temperature of 1,800-2,800° C. at which carbon radicals, hydrogen radicals and the like generate, and the conductive substrate in the atmosphere is set to a temperature region (750-950° C.) at which diamond precipitates. In some embodiments, the proportion of the organic compound raw material to hydrogen is preferably 0.1-10 vol %, and the content of the dopant is preferably 1-100,000 ppm, e.g. from 100-10,000 ppm. Supply rate of the raw material gas varies depending on a size of a reactor. The pressure may be 15-760 Torr.

During synthesis, a layer of fine diamond particles having a particle diameter of generally 0.001-2 μm may be deposited on the conductive substrate. The thickness of the resulting diamond catalyst layer can be controlled by the deposition time. In some embodiments, the thickness is 0.1-50 μm, e.g. 1-10 μm.

Since the electrode is exposed to a hydrogen atmosphere at a high temperature during CVD, it is desirable that the electrode substrate is thermally and chemically stable, is difficult to undergo hydrogen brittleness, and has a coefficient of thermal expansion close to that of diamond. Suitable substrate materials include, but are not limited to, non-metal materials such as silicon, silicon carbide, graphite or amorphous carbon, and metal materials such as tin, titanium, niobium, zirconium, tantalum, molybdenum or tungsten.

The methods described herein may be used to form a dense and homogeneous thin film. In some embodiments, the thin film may have a film thickness of 1-50 μm.

An ion exchange separator or membrane is used to separate the ions in the redox reaction (redox reaction refers to the reduction and oxidation reaction occurring in the anode cell and the cathode cell) during charging and discharging. In general, the separator is located between the electrodes. In some embodiments, the ion-exchange separator is selected from the group consisting of a cation exchange membrane, an anion exchange membrane, and a microporous separator. In some embodiments, the ion-exchange separator is or includes nafion. Other suitable materials include, for example, nonwoven fibers (cotton, nylon, polyesters, glass), polymer films (polyethylene, polypropylene, poly (tetrafluoroethylene), polyvinyl chloride, naturally occurring substances (rubber, asbestos, wood), and the like. Pores of the separator are of sufficient size to allow the ions of the electrolyte to pass through. Commercial separator materials are generally formed from polymers, such as polyethylene and/or polypropylene that are porous sheets that provide for ionic conduction. Commercial polymer separators include, for example, the Celgard® line of separator material from Hoechst Celanese, Charlotte, N.C. Also, ceramic-polymer composite materials have been developed for separator applications. These composite separators can be stable at higher temperatures, and the composite materials can significantly reduce the fire risk.

In order for diffusion of positive and negative ions to occur through the ion exchange membrane, generally there should be a concentration difference on both sides of the ion exchange membrane and a concentration gradient must exist inside the ion exchange membrane. In addition, a diffusion boundary layer is formed at the boundary between the electrolyte solution and the ion exchange membrane, and the diffusion of the solvent as well as the diffusion of the solute should be considered.

The batteries described herein have a wide range of applications including use as a large-capacity storage battery for stabilizing variations in power generation output, storing surplus generated power, and load leveling for power generation of new energy such as solar photovoltaic power generation and wind power generation. The redox flow battery according to the disclosure can also be suitably used as a large-capacity storage battery attached to a common power plant for voltage sag and power failure prevention and for load leveling. Other applications include use for power conversion, in electric vehicles, and as a stand-alone power system.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### Example: Demonstration of Manganese Redox Couple Using Boron Doped Electrode in Aqueous Environments

### Demonstration of Higher Potential Window for Diamond Electrode

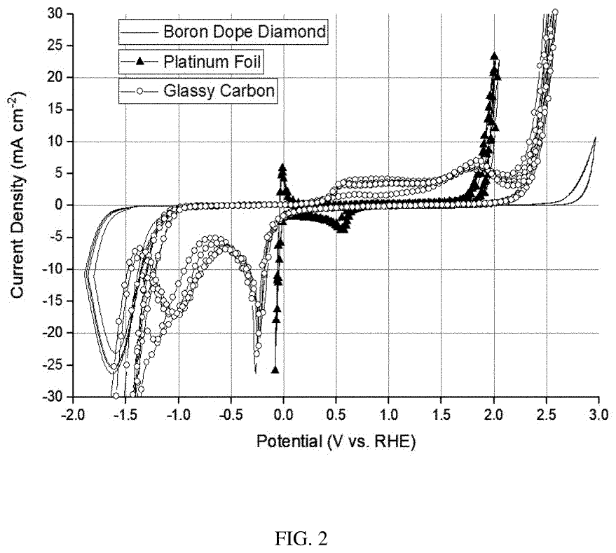

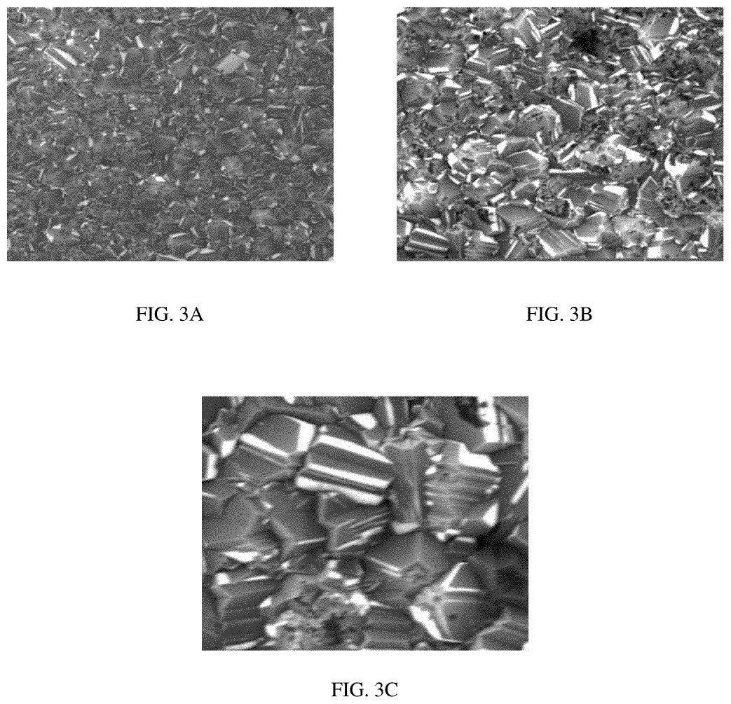

FIG. 2 illustrates that boron doped electrode has a wide potential window with water electrolysis. The results with cyclic voltammetry (CV) on boron doped electrode with other electrodes such as platinum and glassy carbon electrode show that an activity with oxygen evolution reaction does not exist and that there is a low electrochemical double layer capacitance compared to glassy carbon electrode. SEM images of the boron doped diamond surface are shown in FIGS. 3A-C.

Demonstration of Reversible Activity with Manganese Redox Couple

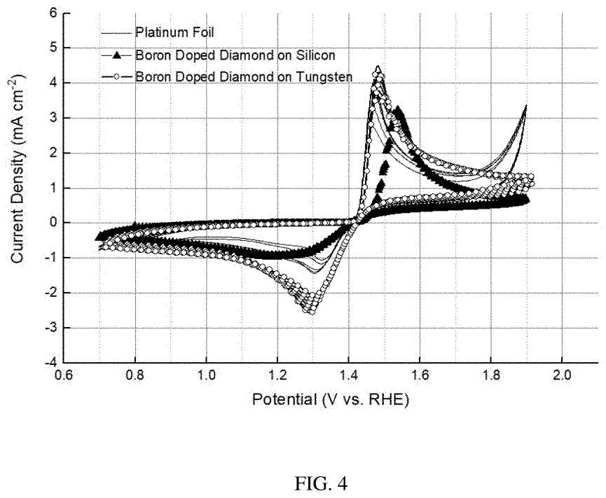

FIG. 4 shows results with good quality diamond films grown on various substrates including tungsten. FIG. 4 demonstrates the CV with manganese redox couple using boron doped diamond (BDD) electrode. The CV curves exhibit a small peak difference in the oxidation and reduction reactions, indicating a high reversibility of this redox couple. Additionally, the small peak difference indicates a low overpotential to the electrochemical reaction of the manganese redox couple; this suggests good kinetics at the BDD surface. The results with BDD indicate that there are no issues/challenges with the oxygen evolution reaction (OER). FIG. 4 shows no peak for OER reaction compared to platinum electrode. When conducted using glassy carbon electrode, the oxygen evolution can slowly degrade the electrode. CV is typically the first method of testing to demonstrate an electrolyte's capability because CV gives a qualitative understanding of the redox couple potential, reaction kinetics, and reversibility.

### Other Redox Couples

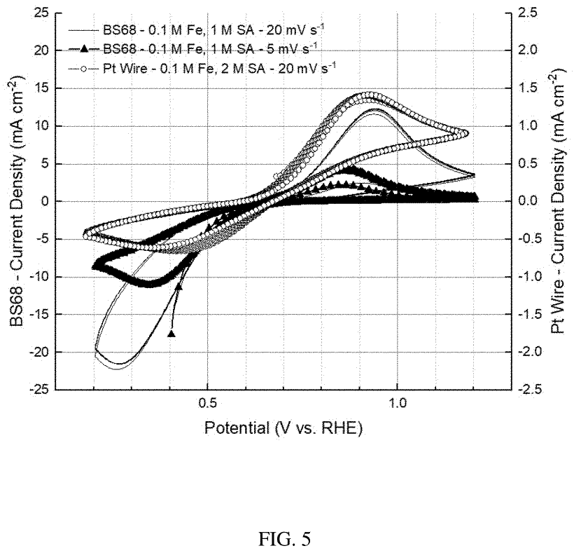

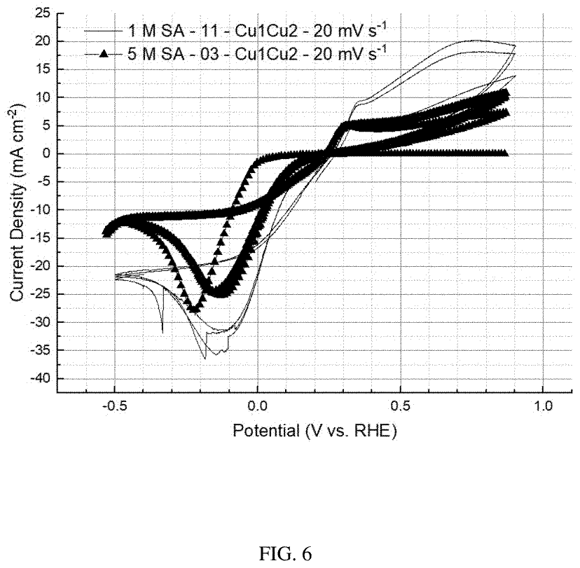

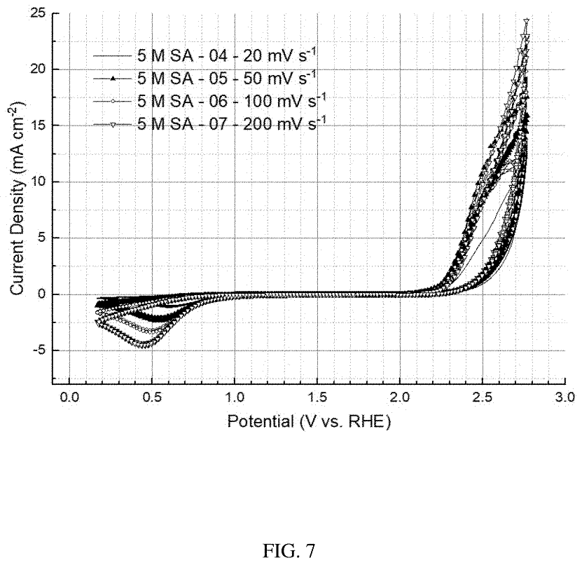

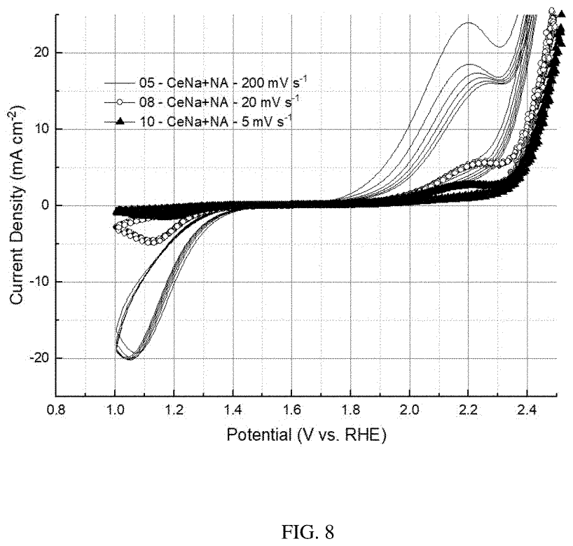

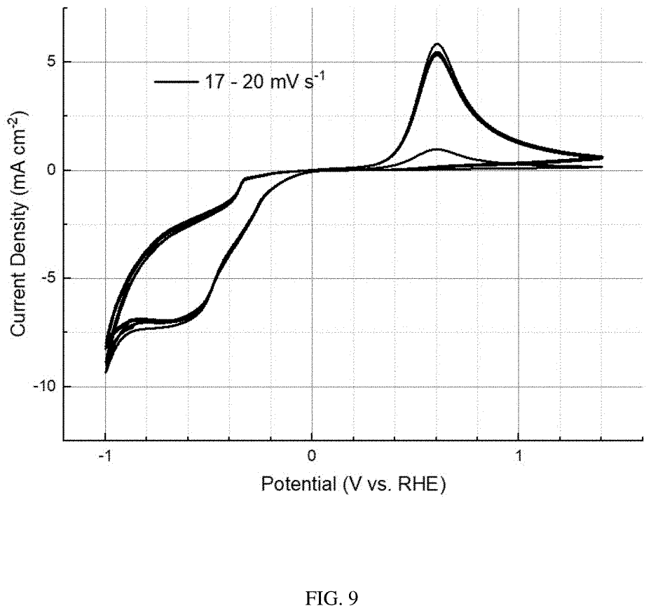

Similar results can be obtained for various redox couples involving iron, chromium, indium, and titanium. In addition, other redox couples, with a more positive potential compared to manganese, are also possible. This includes, but is not limited to, cerium, silver, cobalt, iron, and copper. FIG. 5 shows the iron redox couple on boron doped diamond compared to platinum wire. FIG. 6 shows the copper redox couple on boron doped diamond. FIG. 7 shows the cobalt redox couple on boron doped diamond. FIG. 8 shows the cerium redox couple on boron doped diamond. FIG. 9 shows the titanium redox couple on boron doped diamond.

### REFERENCES

Alotto, P., Guarnieri, M., & Moro, F. (2014). Redox flow batteries for the storage of renewable energy: A review. Renewable and Sustainable Energy Reviews, 29, 325-335. Retrieved from sciencedirect.com/science/article/pii/S1364032113005418. doi:https://doi.org/10.1016/j.rser.2013.08.001
Dong-Jun, P., Kwang-Sun, J., Cheol-Hwi, R., & Gab-Jin, H. (2017). Performance of the all-vanadium redox flow battery stack. Journal of Industrial and Engineering Chemistry, 45, 387-390. Retrieved from dx.doi.org/10.1016/j.jiec.2016.10.007. doi:10.1016/j.jiec.2016.10.007
Laboratories, S. N. (2018). DOE Global Energy Storage Database. Retrieved Nov. 12, 2018 energystorageexchange.org/projects
Made-in-China.com. (2018). Retrieved from made-in-china.com/products-search/hot-china-products/Manganese_Sulfate.html made-in-china.com/products-search/hot-china-products/Vanadyl_Sulfate.html
Reynard, D., Dennison, C. R., Battistel, A., & Girault, H. H. (2018). Efficiency improvement of an all-vanadium redox flow battery by harvesting low-grade heat. Journal of Power Sources, 390, 30-37. Retrieved from sciencedirect.com/science/article/pii/50378775318303252. doi:doi.org/10.1016/j.jpowsour.2018.03.074
Soloveichik, G. L. (2015). Flow Batteries: Current Status and Trends. Chemical Reviews, 115(20), 11533-11558. Retrieved from doi.org/10.1021/cr500720t. doi:10.1021/cr500720t
University, B. (2018). BU-210b: How does the Flow Battery Work? Retrieved from batteryuniversity.com/learn/article/bu_210b_flow_battery
Vanýsek, P. (1996). Modern techniques in electroanalysis. New York: Wiley.
Xu, Q., Ji, Y. N., Qin, L. Y., Leung, P. K., Qiao, F., Li, Y. S., & Su, H. N. (2018). Evaluation of redox flow batteries goes beyond round-trip efficiency: A technical review. Journal of Energy Storage, 16, 108-115. Retrieved from sciencedirect.com/science/article/pii/S2352152X17305066. doi:doi.org/10.1016/j.est.2018.01.005
Yang, Z. G. (2017). It's Big and Long-Lived, and It Won't Catch Fire: The Vanadium Redox-Flow Battery. Retrieved from spectrum.ieee.org/green-tech/fuel-cells/its-big-and-longlived-and-it-wont-catch-fire-the-vanadium-redoxflow-battery

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A redox flow battery, comprising:
a positive electrode;
a positive electrode electrolyte which contains a first type of redox active material, wherein the positive electrode electrolyte is in contact with the positive electrode;
a negative electrode;
a negative electrode electrolyte which contains a second type of redox active material, wherein the negative electrode electrolyte is in contact with the negative electrode; and
an ion-exchange separator between the positive electrode electrolyte and the negative electrode electrolyte configured to charge and discharge the battery,
wherein at least one of the positive electrode and the negative electrode is a conductive diamond electrode, and
wherein at least one of the positive electrode electrolyte and the negative electrode electrolyte is in contact with diamond.

2. The redox flow battery of claim 1, wherein the diamond contacted by the at least one of the positive electrode electrolyte and the negative electrode electrolyte is in the conductive diamond electrode.

3. The redox flow battery of claim 1, wherein both the positive electrode and the negative electrode are conductive diamond electrodes.

4. The redox flow battery of claim 1, wherein both the positive electrode electrolyte and the negative electrode electrolyte are in contact with diamond.

5. The redox flow battery of claim 1, wherein the conductive diamond electrode is made of at least one type of material selected from the group consisting of boron doped diamond, nitrogen incorporated diamond, phosphorus doped diamond, a composite material including a p-type conductive diamond layer and a n-type conductive diamond layer, and a composite material including a doped diamond with a metal oxide thin film including at least one type of metal.

6. The redox flow battery of claim 5, wherein the conductive diamond electrode is the composite material including the doped diamond and the metal oxide thin film, wherein the doped diamond is boron doped diamond, and wherein the metal oxide thin film includes one or more metals selected from the group consisting of titanium, molybdenum, tin, and tungsten.

7. The redox flow battery of claim 5, wherein the conductive diamond electrode is grown on a patterned substrate.

8. The redox flow battery of claim 5, wherein the conductive diamond electrode is grown on a porous substrate.

9. The redox flow battery of claim 5, wherein the conductive diamond electrode is porous.

10. The redox flow battery of claim 5, wherein the conductive diamond electrode is etched.

11. The redox flow battery of claim 1, wherein the first type of redox active material is different from the second type of redox active material.

12. The redox flow battery of claim 1, wherein the first type of redox active material is the same as the second type of redox active material.

13. The redox flow battery of claim 1, wherein each of the positive electrode electrolyte and the negative electrode electrolyte, which may be the same or different, contain at least one type of redox couple selected from the group consisting of transition metals, lanthanides, and halogens.

14. The redox flow battery of claim 13, wherein the at least one type of redox couple is a transition metal selected from the group consisting of Ti, V, Cr, Mn, Fe, Co, Cu, Zn, Ag, and Sn.

15. The redox flow battery of claim 13, wherein the at least one type of redox couple is Ce.

16. The redox flow battery of claim 13, wherein the at least one type of redox couple is a halogen selected from the group consisting of chlorine, bromine, and iodine.

17. The redox flow battery of claim 1, wherein the positive electrode electrolyte contains at least one type of redox couple and has a thermodynamic potential of not less than 1 volt.

18. The redox flow battery of claim 1, wherein the negative electrode electrolyte contains at least one type of redox couple and has a thermodynamic potential of not more than 0.8 volts.

19. The redox flow battery of claim 1, wherein each of the positive electrode electrolyte and the negative electrode electrolyte have a concentration of not less than 0.1 M and not more than 10 M.

20. The redox flow battery of claim 1, wherein each of the positive electrode electrolyte and the negative electrode electrolyte contains a solvent which may be the same or different for the positive electrode electrolyte and the negative electrode electrolyte, wherein the solvent is an aqueous solution containing at least one species selected from the group consisting of H₂SO₄, HCl, HClO₄, CH₃SO₃H, K₂SO₄, Na₂SO₄, H₃PO₄, K₂PO₄, Na₃PO₄, K₃PO₄, H₄P₂O₇, HNO₃, KNO₃, NaNO₃, NaOH, and KOH.

21. The redox flow battery of claim 1, wherein the ion-exchange separator is selected from the group consisting of a cation exchange membrane, an anion exchange membrane, and a microporous separator.

22. The redox flow battery of claim 21, wherein the ion-exchange separator is or includes nafion.

23. Boron doped diamond configured as an electrode in a redox flow battery.

24. Boron doped diamond configured as at least one of the positive and negative electrodes of the redox flow battery of claim 1.

25. A conductive diamond configured as an electrode in a redox flow battery whereby either redox couple is of any species other than those containing Mn or Ti.

26. A conductive diamond configured as at least one of the positive and negative electrodes of the redox flow battery of claim 1 whereby either redox couple is of any species other than those containing Mn or Ti.
